(19) United States
(12) Patent Application Publication
(10) Pub. No.: US 2025/0373680 A1
(43) Pub. Date: Dec. 4, 2025

(54) CONTROL METHOD, ELECTRONIC DEVICE, AND STORAGE MEDIUM

(71) Applicant: Lenovo (Beijing) Limited, Beijing (CN)

(72) Inventors: Qihua XIAO, Beijing (CN); Yongyan GONG, Beijing (CN); Haitao FAN, Beijing (CN)

(21) Appl. No.: 19/204,597

(22) Filed: May 11, 2025

(30) Foreign Application Priority Data
May 31, 2024 (CN) 202410696922.4

(51) Int. Cl. H04L 67/06; H04L 67/143

(52) U.S. Cl. CPC H04L 67/06; H04L 67/143

(57) ABSTRACT

A control method includes determining a device status of a first device; in response to that the device status of the first device satisfies a first condition, controlling the first device to broadcast a scan signal, such that a second device receiving the scan signal starts a second application when a second condition is satisfied; and establishing a data connection between a first application of the first device and the second application of the second device.

### CROSS-REFERENCE TO RELATED APPLICATION

This application claims the priority of Chinese Patent Application No. 202410696922.4, filed on May 31, 2024, the content of which is incorporated herein by reference in its entirety.

### TECHNICAL FIELD

The present disclosure generally relates to the field of data processing technology, and, more particularly, relates to, a control method, an electronic device, and a storage medium.

### BACKGROUND

Certain applications are installed on both a mobile phone and a computer; and corresponding functions are implemented through direct connection between the applications.

Currently, users need to manually start applications on both the mobile phone and the computer to implement the interconnection between the applications. Such manner may result in high complexity of user operation and poor user experience.

### SUMMARY

One aspect of the present disclosure provides a control method. The control method includes determining a device status of a first device; in response to that the device status of the first device satisfies a first condition, controlling the first device to broadcast a scan signal, such that a second device receiving the scan signal starts a second application when a second condition is satisfied; and establishing a data connection between a first application of the first device and the second application of the second device.

Another aspect of the present disclosure provides an electronic device. The electronic device includes a memory, configured to store a computer program; and one or more processors, configured to, when the computer program is executed, perform a control method. The control method includes determining a device status of a first device; in response to that the device status of the first device satisfies a first condition, controlling the first device to broadcast a scan signal, such that a second device receiving the scan signal starts a second application when a second condition is satisfied; and establishing a data connection between a first application of the first device and the second application of the second device.

Another aspect of the present disclosure provides a non-transitory computer-readable storage medium, containing a computer program for when executed by one or more processors, performing a control method. The control method includes determining a device status of a first device; in response to that the device status of the first device satisfies a first condition, controlling the first device to broadcast a scan signal, such that a second device receiving the scan signal starts a second application when a second condition is satisfied; and establishing a data connection between a first application of the first device and the second application of the second device.

Other aspects of the present disclosure may be understood by those skilled in the art in light of the description, the claims, and the drawings of the present disclosure.

### BRIEF DESCRIPTION OF THE DRAWINGS

To clearly describe the technical solutions of various embodiments of the present disclosure, the drawings need to be used for describing various embodiments are described below. Obviously, the drawings in following description are merely some embodiments of the present disclosure. For those skilled in the art, other drawings may be obtained in accordance with these drawings without creative efforts.

FIG. 1 illustrates a flowchart of a control method according to exemplary embodiment one of the present disclosure.

FIG. 2 illustrates an exemplary schematic of implementing data transmission between a first application and a second application according to various embodiments of the present disclosure.

FIG. 3 illustrates an exemplary schematic of implementing application data connection between three devices according to various embodiments of the present disclosure.

FIG. 4 illustrates an exemplary schematic of implementing application data connection between two devices according to various embodiments of the present disclosure.

FIG. 5 illustrates another exemplary schematic of implementing application data connection between three devices according to various embodiments of the present disclosure.

FIG. 6 illustrates an exemplary schematic of monitoring a position of a mobile phone operator according to various embodiments of the present disclosure.

FIG. 7 illustrates an exemplary schematic of monitoring a position of a PC operator according to various embodiments of the present disclosure.

FIG. 8 illustrates a flowchart of a control method according to exemplary embodiment two of the present disclosure.

FIG. 9 illustrates a structural schematic of an electronic device according to exemplary embodiment three of the present disclosure.

FIG. 10 illustrates a structural schematic of an electronic device according to exemplary embodiment four of the present disclosure.

FIG. 11 illustrates an exemplary schematic of implementing application data transmission scenario between a mobile phone and a PC according to various embodiments of the present disclosure.

FIG. 12 illustrates a flowchart of application connection between a mobile phone and a PC according to various embodiments of the present disclosure.

### DETAILED DESCRIPTION

To clearly describe the objectives, the technical solutions and advantages of the present disclosure, the technical solutions of the present disclosure are further described in detail below in combination with accompanying drawings and embodiments. The described embodiments should not be regarded as limiting the present disclosure. All other embodiments obtained by those skilled in the field without creative work are within the protection scope of the present disclosure.

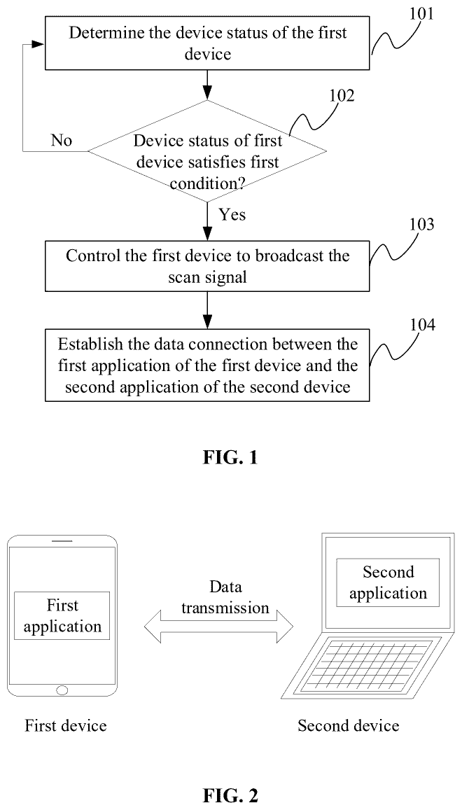

Referring to FIG. 1, FIG. 1 illustrates a flowchart of a control method according to exemplary embodiment one of the present disclosure. The method may be applied to an electronic device capable of running an application program. Such electronic device may be configured as the first device deployed with a signal generator capable of broadcasting scan signals, such as a mobile phone with a speaker. The technical solution in one embodiment may be configured to reduce the complexity of user operations and improve the user experience.

Exemplarily, the method in one embodiment may include following exemplary steps.

At 101, the device status of the first device may be determined.

The device status may include at least one of the following, including the device attitude change of the first device, the object image-forming information collected by the first device, the environmental change status of the first device, and the device application scenario of the first device.

In an implementation manner, the device status may be obtained through a corresponding sensor or information collection part. For example, the device attitude change of the first device may be obtained by collecting current device attitude of the first device through an inertial measurement unit (IMU), and the device attitude change may characterize whether the operator of the first device needs to start the first application and transmit application data. For another example, the object image-forming information collected by the first device may be obtained through a TOF (Time of flight) sensor, an infrared remote sensing sensor, a camera or the like, and the object image-forming information may characterize whether there are other devices in front of the first device. For another example, the environmental change status of the first device may be obtained by collecting the light parameter of surrounding environment through an optical sensor, and the environmental change status may characterize whether screen light of other devices is in front of the first device. The device application scenario of the first device may be obtained by identifying the usage scenario of the first device through a processor, and the device application scenario may characterize whether the first device is in the usage scenario where the first application needs to be started, and application data needs to be transmitted.

At 102, whether the device status of the first device satisfies the first condition may be determined. In response to that the device status of the first device satisfies the first condition, exemplary step 103 may be executed. In response to that the device status of the first device does not satisfy the first condition, exemplary step 101 may be returned to be executed, such that the device status of the first device may be monitored continuously.

In an implementation manner, the device status of the first device satisfying the first condition may be that the device attitude change of the first device may match a preset target attitude.

The target attitude may be an attitude configured according to requirements, or an attitude configured by factory default. Exemplarily, the first device as a mobile phone is taken as an example. The mobile phone may output a configuration interface for the user, and the user may configure a certain attitude on the configuration interface, such as the mobile phone flipping over three times in a row. Based on the above, in response to that the IMU on the mobile phone collects that the mobile phone flips over three times in a row, it may indicate that the mobile phone and the PC may need to be interconnected by application and determine that the device attitude change of the mobile phone may match the target attitude.

In another implementation manner, the device attitude of the first device satisfying the first condition may be that the object image-forming information collected by the first device may indicate the existence of the second device.

Exemplarily, the first device as a mobile phone is taken as an example. The TOF sensor on the mobile phone may collect the object image-forming information in the front range and perform object contour recognition on the object image-forming information. In response to that the object contour matching the contour of a personal computer PC is recognized, it may indicate that the mobile phone and the PC may need to be interconnected by applications and determine that the object image-forming information collected by the mobile phone may indicate the existence of a PC.

In another implementation manner, the device attitude of the first device satisfying the first condition may be that the environment change status of the first device may match a preset target environment status.

The environment change status may be a light change status. Exemplarily, the first device as a mobile phone is taken as an example. The optical sensor on the mobile phone may collect the light status of the front environment. For example, the mobile phone may be close to the PC display screen. In response to that the light status in front of the mobile phone characterizes that the PC screen outputs light, the optical sensor sensing value on the mobile phone may change, which may indicate that the mobile phone and the PC may need to be interconnected by applications. Therefore, it may determine that the environment change status of the mobile phone may match the target environment status corresponding to the PC.

In another implementation manner, the device application scenario of the first device may match the preset target application scenario.

The target application scenario may be an application scenario where a certain application is running on the first device, or a certain scenario where the first device is used. For example, the target application scenario may be that an application which needs to perform file transfer is running; or may be a usage scenario that the first device is in a multi-person conference. Exemplarily, the first device as a mobile phone is taken as an example. In response to that a conference application is opened on the mobile phone, it may indicate that the mobile phone and the PC may need to be interconnected by applications. At this point, it may determine that the device application scenario of the mobile phone may match the target application scenario.

At 103, the first device may be controlled to broadcast a scan signal.

The scan signal may be a sound wave signal, such as an ultrasonic signal or a micrometer wave signal or a millimeter wave radar signal.

In an implementation manner, in exemplary step 103, the scan signal may be broadcasted by a signal generator in the first device. The signal generator may be a part such as a speaker, a micro radar or the like.

It should be noted that after the first device broadcasts the scan signal, the second device in the receiving range of the scan signal may receive the scan signal. Based on the above, the second device that receives the scan signal may start the second application when the second condition is satisfied.

The first application may be configured on the first device; and the first application and the second application may be applications performing data connection and data transmission, such as collaborative programs Intel Unison and/or the like.

The second condition may be related to the relative position status between the second device and the first device. For example, the second condition may be that the relative position status between the second device and the first device may match the preset target position status. For example, the relative position status between the second device and the first device may be characterized by the device distance between the second device and the first device, and/or the device direction of the second device relative to the first device.

In an implementation manner, the second condition being satisfied may include that the device distance between the second device and the first device may be less than or equal to the distance threshold, and/or the device direction of the second device relative to the first device may match the preset relative direction. For example, the PC may be in a certain orientation relative to the mobile phone.

At 104, data connection between the first application of the first device and the second application of the second device may be established.

On the first device, the data connection may be established between the first application started on the first device and the second application started on the second device, such that data may be transmitted between the first application and the second application, as shown in FIG. 2.

It may be seen from above-mentioned technical solutions that in the control method provided in exemplary embodiment one of the present disclosure, the first device may be controlled to broadcast the scan signal based on that the device status of the first device satisfies the first condition, such that when the scan signal is received on the second device, the second application may be started in response to that the second condition is satisfied. Based on the above, the data connection between the first application of the first device and the second application of the second device may be established. It may be seen that in one embodiment, the data connection between the applications on two devices may be controlled to be established based on the device status, and the application interconnection may be implemented without the user performing operations such as application startup on two devices, thereby reducing the user's operation complexity and improving the user experience.

In an implementation manner, before exemplary step 104, the method in one embodiment may further include the following processing: after controlling the first device to broadcast the scan signal, starting the first application in the first device; or when the relative position status between the second device and the first device satisfies the second condition, starting the first application in the first device; or after establishing the device connection between the second device and the first device, starting the first application in the first device.

The relative position status may be obtained according to the feedback signal sent by the second device after receiving the scan signal; or the relative position status may be received from the second device.

That is, in one embodiment, the first application may be started after the first device is controlled to broadcast the scan signal; or the first application may be started when the relative position status between the second device and the first device satisfies the second condition; or the first application may be started after the device connection is established between the second device and the first device, and the device connection may be established when the relative position status between the second device and the first device satisfies the second condition.

For example, after receiving the feedback signal sent by the second device, the first device may process the feedback signal to identify the relative position status (e.g., the device distance and/or device direction) of the second device relative to the first device. Or after receiving the feedback signal sent by the second device, the first device may extract the relative position status in the feedback signal.

Exemplarily, the first device as a mobile phone is taken as an example. After the mobile phone broadcasts an ultrasonic signal through a speaker, the Unison application on the mobile phone may be started.

For another example, after the mobile phone broadcasts the ultrasonic signal through the speaker, the PC may receive the ultrasonic signal and send a feedback signal to the mobile phone. The feedback signal may contain the relative position status of the PC obtained by the PC. After receiving the feedback signal, the mobile phone may extract the relative position status from the feedback signal.

For another example, after the mobile phone broadcasts the ultrasonic signal through the speaker, the PC may receive the ultrasonic signal and send the feedback signal to the mobile phone. After receiving the feedback signal, the mobile phone may identify the device distance and/or device direction of the PC relative to the mobile phone according to the feedback signal, thereby obtaining the relative position status.

In an implementation manner, before exemplary step 104, the method in one embodiment may further include the following processing: when receiving feedback signals from the plurality of receiving devices, selecting at least one second device satisfying the third condition from the plurality of receiving devices based on the device position of each receiving device.

The third condition may be at least one of the following: the device distance between the second device and the first device may be less than or equal to the distance threshold; the device direction of the second device relative to the first device may match the preset relative direction; and the second device may be a device in the first N devices among the plurality of receiving devices sorted in ascending order according to the device distance between the second device and the first device, where N may be a positive integer greater than or equal to 1.

It should be noted that the device position of the receiving device may be obtained according to the feedback signal sent by the receiving device or extracted from the feedback signal sent by the receiving device.

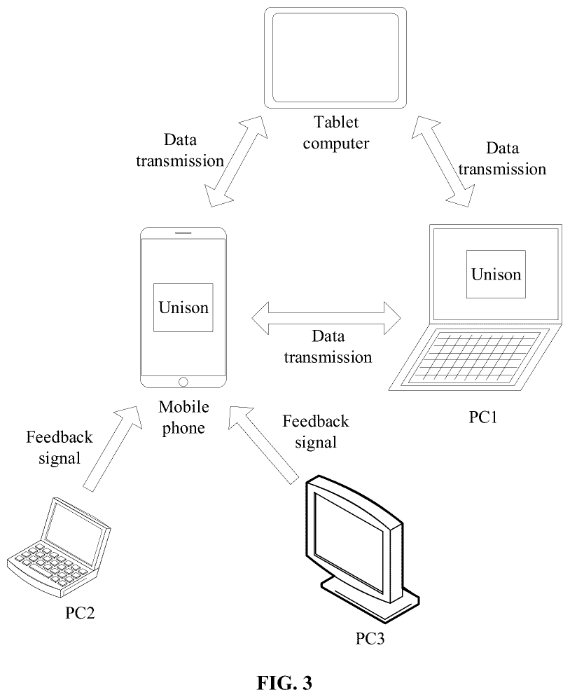

The first device as a mobile phone is taken as an example. Exemplarily, four receiving devices, such as PC1, PC2, PC3, and a tablet computer, may send feedback signals to the mobile phone respectively; and the mobile phone may determine corresponding device distances and/or device directions according to the device positions of PC1, PC2, PC3, and the tablet computer relative to the mobile phone, and select the second devices (e.g., PC1 and the tablet computer) which may have device directions matching the preset relative direction, have device distances less than or equal to the distance threshold and have device distances ranked in the first two in ascending order, as shown in FIG. 3. Next, the data connection may be established between the Unison application in PC1, the Unison application in the tablet computer, and the Unison application in the mobile phone to implement data transmission among three receiving devices.

In an implementation manner, before exemplary step 104, the method in one embodiment may further include the following processing: when receiving feedback signals from the plurality of receiving devices, in response to device selection operations for the plurality of receiving devices, determining at least one second device among the plurality of receiving devices.

For example, a selection interface may be outputted on the first device, and the selection interface may output the device identification of each receiving device, which may be provided to the user for device selection operation. Based on the above, the user's device selection operation may be received on the first device, and one or more receiving devices may be determined to be the second device according to the device selection operation.

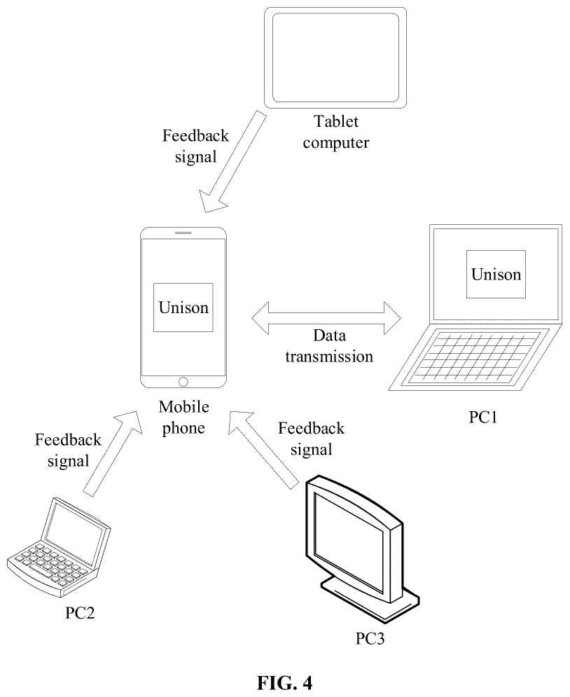

The first device as a mobile phone is taken as an example. Exemplarily, four receiving devices, such as PC1, PC2, PC3, and a tablet computer, may send feedback signals to the mobile phone respectively; the mobile phone may output the selection interface and receive the device selection operation performed by the user on the selection interface; according to the device selection operation, the mobile phone may determine that PC1 is the second device, as shown in FIG. 4; and the data connection may be then established between the Unison application in PC1 and the Unison application in the mobile phone to implement data transmission between two receiving devices.

In an implementation manner, before step 104, the method in one embodiment may further include the following processing: when receiving feedback signals from the plurality of receiving devices, determining at least one second device from the plurality of receiving devices according to the historical connection information of the first device.

The historical connection information of the first device may include the information of the devices to which the first device has been historically connected.

The first device as a mobile phone is taken as an example. Exemplarily, according to the devices to which the mobile phone has been historically connected, the PC, which is consistent with the devices to which the mobile phone has been historically connected, may be selected from the receiving PCs as the second device.

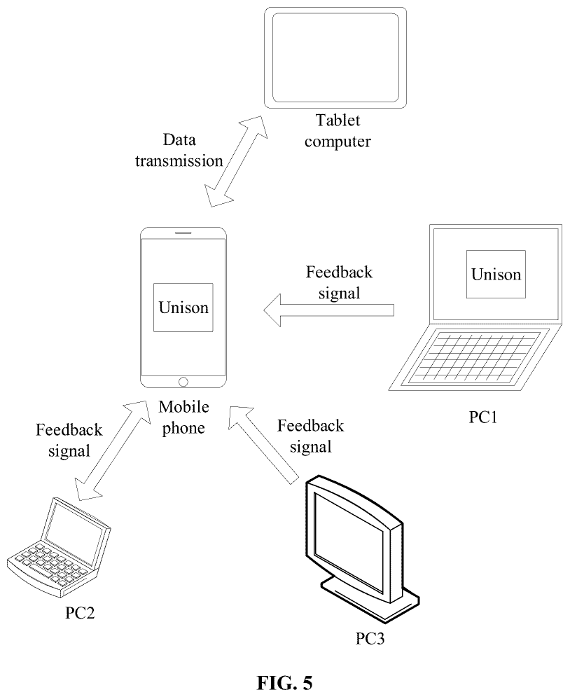

The first device as a mobile phone is taken as an example. Exemplarily, four receiving devices, such as PC1, PC2, PC3, and a tablet computer, may send feedback signals to the mobile phone respectively, according to the devices to which the mobile phone has been historically connected (e.g., PC2 and the tablet computer), above-mentioned two devices may be determined as the second device, as shown in FIG. 5. Next, the data connection may be established between the Unison application in PC2, the Unison application in the tablet computer, and the Unison application in the mobile phone to implement data transmission among three receiving devices.

In an implementation manner, after exemplary step 104, the method in one embodiment may further include the following processing: the first device monitors whether the first device or the second device satisfies the fourth condition; and when the first device or the second device satisfies the fourth condition, at least one of the following processes is performed: suspending the data transmission between the first application and the second application through the data connection (for example, the data transmission between the Unison application of the mobile phone and the Unison application of the PC may be suspended); adjusting the data transmission parameters of the data connection, where the data transmission parameters may include at least one of the signal transmission frequency, transmission rate, and channel bandwidth of the data connection (for example, the data transmission rate, or transmission rate, or channel bandwidth of the data transmission on the data connection may be reduced); and hibernating the first device and/or the second device (for example, the mobile phone may switch itself to hibernation, and/or the mobile phone may send a hibernation instruction to the PC, such that the PC may switch itself to hibernation mode).

The fourth condition may include that the relative position of the first device and the second device may exceed the preset position range; or the device application scenario of the first device or the second device may not match the preset target application scenario; or the first device and the second device may not receive any operation for a continuing target duration.

It may be seen that in one embodiment, the first device may implement energy-saving control during the application data transmission process through the fourth condition, thereby saving data transmission resources between the second device and the first device.

In one embodiment, the relative position between the first device and the second device may be monitored; and in response to that the relative position is not within the preset position range, it may determine that the first device satisfies the fourth condition. The preset position range may be the position range configured under the second condition or a position range different from the position range configured under the second condition.

In another embodiment, in response to that the duration of the relative position not being within the preset position range reaches a preset threshold, it may determine that the first device may satisfies the fourth condition.

For example, during the process of data transmission between the Unison application of the mobile phone and the Unison application of the PC via data connection, the mobile phone may be not within the preset position range, or the duration of the mobile phone not being within the preset position range may reach a preset threshold, such that the data transmission parameters between the Unison application of the mobile phone and the Unison application of the PC may be adjusted.

For another example, during the process of data transmission between the Unison application of the mobile phone, the Unison application of the tablet, and the Unison application of the PC through the data connection, in response to that at least one of the second devices is not within the preset position range (for example, the tablet may be not within the preset position range) but the PC may be within the preset position range, the application connection between the mobile phone and the PC may be maintained, but the data transmission parameters between the tablet and the mobile phone may be adjusted.

Or the fourth condition may be that the position of the operator of the first device or the second device may exceed the preset position range; or the continuing duration of the position of the operator of the first device or the second device exceeding the preset position range may be greater than or equal to the duration threshold.

In one embodiment, the first device may monitor the position of the operator of the first device relative to the first device; and in response to that the position of the operator of the first device relative to the first device exceeds the preset position range and the continuing duration reaches the duration threshold, it may determine that the first device satisfies the fourth condition.

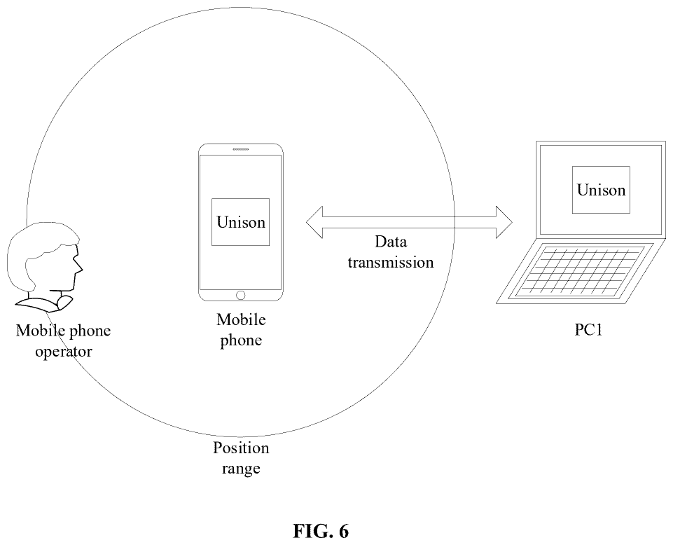

For example, during the process of data transmission between the Unison application of the mobile phone and the Unison application of the PC via data connection, the mobile phone may monitor the position of the mobile phone operator relative to the mobile phone; and in response to that the position of the mobile phone operator relative to the mobile phone exceeds the position range which is with the mobile phone as the center and a radius of 2 meters (as shown in FIG. 6), it may determine that the mobile phone satisfies the fourth condition. At this point, the data transmission rate between the Unison application of the mobile phone and the Unison application of the PC may be reduced.

In another embodiment, the first device may monitor the position of the operator of the second device relative to the second device. For example, the first device may receive the transmission signal sent by the second device and monitor the position of the operator of the second device relative to the second device based on the transmission signal. In response to that the position of the operator of the second device relative to the second device exceeds the preset position range and the continuing duration reaches the duration threshold, it may determine that the second device satisfies the fourth condition.

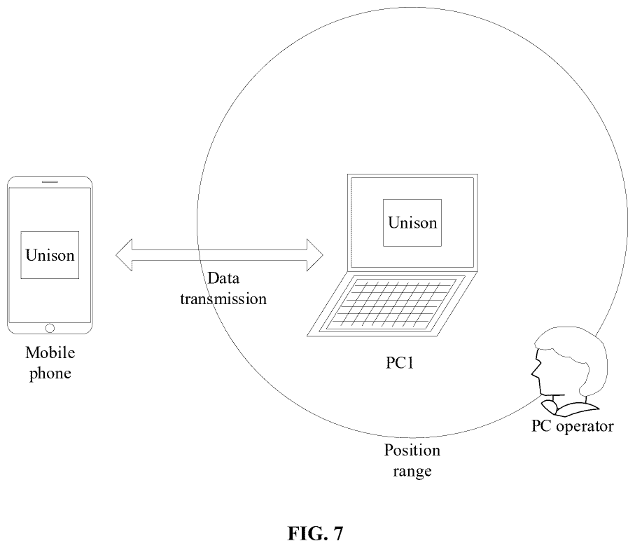

For example, during the process of data transmission between the Unison application of the mobile phone and the Unison application of the PC via data connection, the mobile phone may receive the transmission signal sent by the PC and monitor the position of the PC operator relative to the PC based on the transmission signal. In response to that the position of the PC operator relative to the PC exceeds the position range which is with the PC as the center and a radius of 2 meters (as shown in FIG. 7), it may determine that the PC satisfies the fourth condition. At this point, the data transmission between the Unison application of the mobile phone and the Unison application of the PC may be suspended.

In another embodiment, the first device may monitor the device application scenario of the first device; and in response to that the device application scenario of the first device does not match the preset target application scenario, then it may determine that the first device satisfies the fourth condition.

For example, during the process of data transmission between the Unison application of the mobile phone and the Unison application of the PC via data connection, the mobile phone may monitor whether the application program running on the mobile phone or the used scenario matches the target application scenario. In response to that the application program running on the mobile phone or the used scenario does not match the target application scenario, it may determine that the mobile phone satisfies the fourth condition. At this point, the data transmission between the Unison application of the mobile phone and the Unison application of the PC may be suspended.

In another embodiment, the first device may monitor the device application scenario of the second device. For example, the first device may receive the transmission signal sent by the second device and monitor the device application scenario of the second device based on the transmission signal. In response to that the device application scenario of the second device does not match the preset target application scenario, it may determine that the second device satisfies the fourth condition.

For example, during the process of data transmission between the Unison application of the mobile phone and the Unison application of the PC via data connection, the mobile phone may receive the transmission signal sent by the PC and monitor the device application scenario of the PC based on the transmission signal. In response to that the device application scenario of the PC does not match the preset target application scenario, it may determine that the PC device satisfies the fourth condition. At this point, the data transmission rate between the Unison application of the mobile phone and the Unison application of the PC may be reduced.

In another embodiment, the first device may monitor whether the first device has not received operations for a continuing target duration and whether the second device has not received operations for a continuing target duration. For example, the first device may receive the transmission signal sent by the second device and monitor whether the second device has not received operations for a continuing target duration based on the transmission signal. In response to that the first device and the second device have not received operations for a continuing target duration, it may determine that the fourth condition is satisfied.

For example, in the process of data transmission between the Unison application of a mobile phone and the Unison application of a PC via data connection, the mobile phone may receive the transmission signal sent by the PC and monitor whether the PC has not received operations for a continuing target duration based on the transmission signal, and also monitor whether the mobile phone has not received operations for a continuing target duration. In response to that the PC and the mobile phone have not received operations for a continuing target duration, it may determine that the mobile phone and the PC satisfies the fourth condition. At this point, the data transmission rate between the Unison application of the mobile phone and the Unison application of the PC may be reduced.

In an implementation manner, the scan signal broadcasted by the first device may at least include an identification code of the first device, and the identification code of the first device may be used by the second device to verify the authentication of the first device. When the first device passes the (authentication) verification, the device connection may be established between the first device and the second device, and the device connection may be configured to implement data connection.

For example, when the first device broadcasts the scan signal, the identification code of the first device may be carried in the scan signal. After the second device receives the scan signal, the second device may first extract the identification code therein and perform authentication verification on the first device according to the identification code. For example, the extracted identification code may be compared with a preset character string. In response to that the extracted identification code is consistent with the preset character string, it may determine that the first device passes the (authentication) verification. As a result, the second device may send a connection request to the first device, and the first device may establish device connection with the second device in response to the connection request. Based on the device connection, the data connection between the first application and the second application may be established between the first device and the second device.

It should be noted that in response to that the first device and the second device are connected for the first time, after the second device extracts the identification code in the scan signal, a pop-up window may be outputted to the user of the second device to prompt a request of establishing connection with the first device. The user may accept or reject the connection on the pop-up window. In response to that the user accepts the connection, the second device may send a connection request to the first device again. The first device may establish the device connection with the second device in response to the connection request. Based on the device connection, the data connection between the first application and the second application may be established between the first device and the second device.

For example, when the mobile phone broadcasts the ultrasonic signal, the mobile phone may add the mobile phone identification code to the ultrasonic signal. When the PC receives the ultrasonic signal, the PC may extract the mobile phone identification code. In response to that no connection is between the PC and the mobile phone, the PC may first output a pop-up window to receive the user's operation of accepting or rejecting the connection. In response to that the user's operation of accepting the connection is received, the PC may send a connection request signal to the mobile phone. The mobile phone may, in response to the signal, establish a WiFi connection or Bluetooth connection between the PC and the mobile phone. Subsequently, based on the connection, the application data connection may be established between the Unison application of the mobile phone and the Unison application of the PC, thereby establishing the data connection between the Unison application of the mobile phone and the Unison application of the PC.

It should be noted that, in the case of determining that there are the plurality of second devices, the first device may first establish the device connection with one of the plurality of second devices, and then establish the device connection between the second device and other second devices using the first device as a transit device, thereby further establishing the data connection between the first application on the first device and the second application on each second device.

For example, the PC and the tablet computer may be determined as the second devices that need application connection with the mobile phone. At this point, after the mobile phone establishes the device connection with the PC, the mobile phone may repeat same processing and use the mobile phone to perform transit authentication to implement the device connection between the three devices including the PC, the mobile phone and the tablet computer, such that networking between the PC, the mobile phone and the tablet computer may be implemented, thereby establishing the data connection between the Unison application in the PC, the Unison application in the tablet computer and the Unison application in the mobile phone.

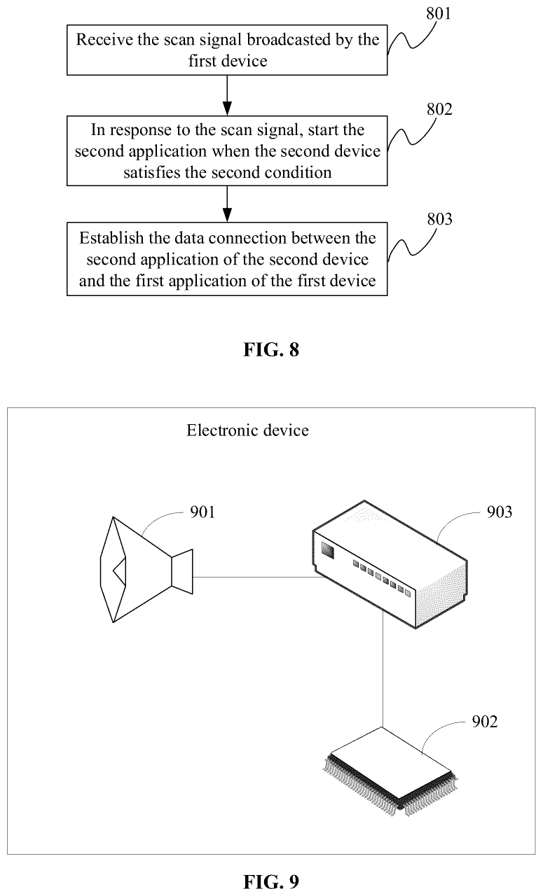

Referring to FIG. 8, FIG. 8 illustrates a flowchart of a control method according to exemplary embodiment two of the present disclosure. The method may be applied to an electronic device capable of running an application program. The electronic device, configured as the second device, may be deployed with a signal receiver capable of receiving the scan signal, such as the PC with a microphone. The technical solution in one embodiment may be configured to reduce the complexity of user operations and improve the user experience.

For example, the method in one embodiment may include the following exemplary steps.

At 801, the scan signal broadcasted by the first device may be received.

The scan signal may be broadcasted by the first device when the first device satisfies the first condition.

At 802, in response to the scan signal, the second application may be started when the second device satisfies the second condition.

The second condition may be related to the relative position status between the second device and the first device. For example, the second condition may be that the relative position status between the second device and the first device matches the preset target position status. For example, the relative position status between the second device and the first device may be characterized by the device distance between the second device and the first device; and/or the relative position status between the second device and the first device may be characterized by the device direction of the second device relative to the first device.

In an implementation manner, the second condition being satisfied may include that the device distance between the second device and the first device is less than or equal to the distance threshold; and/or the device direction of the second device relative to the first device matches the preset relative direction. For example, the PC may be in a certain orientation relative to the mobile phone.

At 803, the data connection between the second application of the second device and the first application of the first device may be established.

It may be seen from above-mentioned technical solution that in the control method provided in exemplary embodiment two of the present disclosure, the first device may be controlled to broadcast the scan signal based on that the device status of the first device satisfies the first condition, such that when the scan signal is received on the second device, the second application may be started in response to that the second condition is satisfied. Based on the above, the data connection between the first application of the first device and the second application of the second device may be established. It may be seen that in one embodiment, the data connection between the applications on two devices may be controlled to be established based on the device status, and the application interconnection may be implemented without the user performing operations such as application startup on two devices, thereby reducing the user's operation complexity and improving the user experience.

In an implementation manner, exemplary step 802 may be implemented in the following manner.

Firstly, according to the scan signal, the communication position of the first device relative to the second device may be obtained; and when the communication position satisfies the second condition, the second application may be started subsequently.

The scan signal may be received on the second device through the plurality of signal receivers such as microphones to obtain multiple channel scan signals, and the communication position of the first device relative to the second device may be analyzed according to the multiple channel scan signals. Next, whether the communication position satisfies the second condition may be determined; and in response to that the communication position satisfies the second condition, the second application may be started.

For example, after the mobile phone sends the ultrasonic signal to the PC, the PC may collect two channel ultrasonic signals through two microphones and locate the source of the ultrasonic signals (that is, the mobile phone) according to two channel ultrasonic signals, thereby obtaining the communication position of the mobile phone relative to the PC. In response to that the device distance between the mobile phone and the PC characterized by the communication position is less than or equal to the distance threshold, it may determine that the communication position satisfies the second condition. At this point, the Unison application on the PC may be started, and the data connection may be established between the Unison application on the mobile phone and the Unison application on the PC, thereby implementing data transmission between the Unison application on the mobile phone and the Unison application on the PC.

In an implementation manner, in response to that scan signals broadcasted by the plurality of first devices are received in exemplary step 801, exemplary step 803 may be implemented in the following manner.

Firstly, the device position of each first device may be obtained according to the scan signal. For example, the multiple channel scan signals corresponding to each first device may be received by the plurality of signal receivers, and the device position of each first device may be located according to the multiple channel scan signals.

Subsequently, according to the device position of the first device, at least one target device may be determined among the plurality of first devices. For example, according to the device position of the first device, at least one target device that satisfies the fifth condition may be selected from the plurality of first devices.

Finally, the data connection may be established between the second application of the second device and the first application of the target device.

The target device satisfying the fifth condition may be at least one of the following: the device distance between the second device and the target device may be less than or equal to the distance threshold; the device direction of the second device relative to the target device may match the preset relative direction; and the target device may be a device in the first M devices in the plurality of first devices sorted in ascending order according to the device distance between the second device and the second device, where M may be a positive integer greater than or equal to 1.

In another implementation manner, in response to that the scan signals, broadcasted by the plurality of first devices, are received in exemplary step 801, exemplary step 803 may be implemented in the following manner: in response to the device selection operations for the plurality of first devices, at least one target device may be determined in the plurality of first devices; and the data connection may be then established between the second application of the second device and the first application of the target device.

In another implementation manner, in response to that the scan signals, broadcasted by the plurality of first devices, are received in exemplary step 801, exemplary step 803 may be implemented in the following manner: according to the historical connection information of the second device, at least one target device may be determined in the plurality of first devices; and the data connection may be then established between the second application of the second device and the first application of the target device.

In an implementation manner, after exemplary step 803, the method in one embodiment may further include the following processing: the second device monitors whether the first device or the second device satisfies the fourth condition; and when the first device or the second device satisfies the fourth condition, at least one of the following processes is performed: suspending the data transmission between the first application and the second application through the data connection (for example, the data transmission between the Unison application of the mobile phone and the Unison application of the PC may be suspended); adjusting the data transmission parameters of the data connection, where the data transmission parameters may include at least one of the signal transmission frequency, transmission rate, and channel bandwidth of the data connection (for example, the data transmission rate, or transmission rate, or channel bandwidth of the data transmission on the data connection may be reduced); and hibernating the first device and/or the second device (for example, the mobile phone may switch itself to hibernation, and/or the mobile phone may send a hibernation instruction to the PC, such that the PC may switch itself to hibernation mode).

The fourth condition may include that the relative position of the first device and the second device may exceed the preset position range; or the device application scenario of the first device or the second device may not match the preset target application scenario.

It may be seen that in one embodiment, the second device may implement energy-saving control during the application data transmission process through the fourth condition, thereby saving data transmission resources between the second device and the first device.

The second device monitoring whether the first device satisfies the fourth condition may be implemented by receiving the transmission signal sent by the first device. For example, the second device may receive the transmission signal sent by the first device, and obtain whether the continuing duration of the position of the operator of the first device exceeding the preset position range is greater than or equal to the duration threshold according to the transmission signal, or obtain whether the device application scenario of the first device does not match the preset target application scenario according to the transmission signal.

Referring to FIG. 9, FIG. 9 illustrates a structural schematic of an electronic device according to exemplary embodiment three of the present disclosure. The electronic device may be a device capable of loading the first application such as Unison application. The electronic device as the first device may include the following structures, including a signal generator 901 (e.g., a speaker); a communication module 902 (e.g., a WiFi module); and a processor 903 (e.g., a central processing unit (CPU)) for determining the device status of the first device. In response to that the device status of the first device satisfies the first condition, the signal generator 901 may be controlled to broadcast the scan signal, such that the second device receiving the scan signal may start the second application when the second condition is satisfied; and the data connection between the first application of the first device and the second application of the second device may be established through the communication module 902.

It may be seen from above-mentioned technical solution that in the electronic device provided in exemplary embodiment three of the present disclosure, the first device may be controlled to broadcast the scan signal based on that the device status of the first device satisfies the first condition, such that when the scan signal is received on the second device, the second application may be started in response to that the second condition is satisfied. Based on the above, the data connection between the first application of the first device and the second application of the second device may be established. It may be seen that in one embodiment, the data connection between the applications on two devices may be controlled to be established based on the device status, and the application interconnection may be implemented without the user performing operations such as application startup on two devices, thereby reducing the user's operation complexity and improving the user experience.

In an implementation manner, the device status of the first device satisfying the first condition may include at least one of the following: the device attitude change of the first device may match the preset target attitude; the object image-forming information collected by the first device may characterize the existence of the second device; the environmental change status of the first device may match the preset target environmental status; and the device application scenario of the first device may match the preset target application scenario.

In an implementation manner, before establishing the data connection between the first application in the first device and the second application of the second device through the communication module 902, the processor 903 may be also configured to, after controlling the first device to broadcast the scan signal, start the first application in the first device; or when the relative position status between the second device and the first device satisfies the second condition, start the first application in the first device.

The relative position status may be obtained according to the feedback signal sent by the second device after receiving the scan signal; or the relative position status may be received from the second device.

In an implementation manner, before establishing the data connection between the first application in the first device and the second application of the second device through the communication module 902, the processor 903 may be further configured to: when receiving feedback signals from the plurality of receiving devices respectively, select at least one second device satisfying the third condition from the plurality of receiving devices at least according to the device position of each receiving device; or when receiving feedback signals from the plurality of receiving devices respectively, determine at least one second device from the plurality of receiving devices in response to the device selection operations for the plurality of receiving devices; or when receiving feedback signals from the plurality of receiving devices respectively, determine at least one second device from the plurality of receiving devices according to the historical connection information of the first device.

In an implementation manner, after establishing the data connection between the first application in the first device and the second application of the second device through the communication module 902, the processor 903 may be further configured to: monitor whether the first device or the second device satisfies the fourth condition; and when the first device or the second device satisfies the fourth condition, perform at least one of the following processes, including suspending the data transmission between the first application and the second application through the data connection, adjusting the data transmission parameters of the data connection and hibernating the first device and/or the second device.

Optionally, the data transmission parameters may include at least one of the signal transmission frequency, transmission rate, and channel bandwidth of the data connection.

The fourth condition may include the continuing duration of the position of the operator of the first device or the second device exceeding the preset position range may be greater than or equal to the duration threshold; or the device application scenario of the first device or the second device may not match the preset target application scenario; or the first device and the second device may not receive any operation at the continuing target duration.

In an implementation manner, the scan signal may at least include the identification code of the first device. The identification code may be used by the second device to verify the authentication of the first device, and when the first device passes the (authentication) verification, the device connection may be established between the first device and the second device, and the device connection may be configured to implement the data connection.

It should be noted that the implementation manner of the processor in one embodiment may refer to above-mentioned description, which may not be described in detail herein.

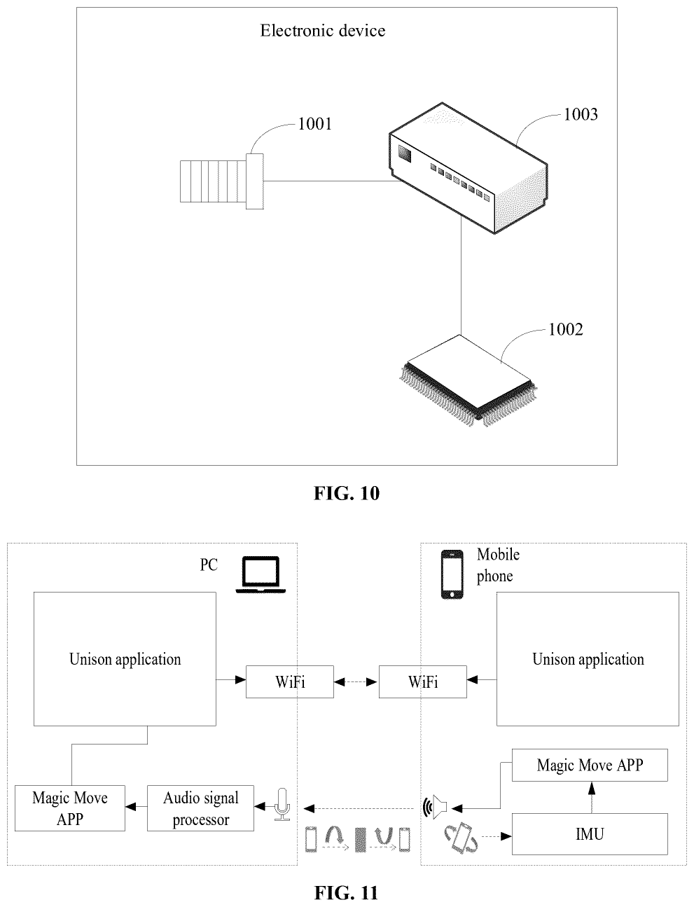

Referring to FIG. 10, FIG. 10 illustrates a structural schematic of an electronic device according to exemplary embodiment four of the present disclosure. The electronic device may be a device capable of loading the second application such as Unison application. The electronic device as the second device may include the following structure, including a signal receiver 1001 (e.g., a microphone) configured to receive the scan signal broadcasted by the first device, where the scan signal may be broadcasted by the first device when the device status of the first device satisfies the first condition; a communication module 1002 (e.g., a WiFi module); a processor 1003 (e.g., a CPU), which is configured to respond to the scan signal, start the second application in response to that the second device satisfies the second condition, and establish the data connection between the second application of the second device and the first application of the first device through the communication module 1002.

It may be seen from above-mentioned technical solution that in the electronic device provided in exemplary embodiment four of the present disclosure, the first device may be controlled to broadcast the scan signal based on that the device status of the first device satisfies the first condition, such that when the scan signal is received on the second device, the second application may be started in response to that the second condition is satisfied. Based on the above, the data connection between the first application of the first device and the second application of the second device may be established. It may be seen that in one embodiment, the data connection between the applications on two devices may be controlled to be established based on the device status, and the application interconnection may be implemented without the user performing operations such as application startup on two devices, thereby reducing the user's operation complexity and improving the user experience.

In an implementation manner, the processor 1003 may be configured to obtain the communication position of the first device relative to the second device according to the scan signal; and start the second application when the communication position satisfies the second condition.

In an implementation manner, in response to that the signal receiver 1001 receives the scan signals broadcasted by the plurality of first devices, before establishing the data connection between the second application of the second device and the first application of the first device through the communication module 1002, the processor 1003 may be further configured to obtain the device position of each first device according to the scan signal; determine at least one target device from the plurality of first devices according to the device position of the first device; and establish the data connection between the second application of the second device and the first application of the target device through the communication module 1002.

It should be noted that the implementation manner of the processor in one embodiment may refer to above-mentioned description, which may not be described in detail herein.

Taking the scenario of data transmission between mobile phone and PC through Unison application as an example, continuous usage of a third-party application may increase the system power consumption (especially for the mobile phone having low-capacity battery), such that the function of the third-party application may be turned off when the third-party application is not in use; and when the third-party application needs to be used, the shortcut key on the computer (i.e., the computer side) and the icon of the application on the mobile phone (i.e., the mobile phone side) may be used to wake up the third-party application. For example, the Unison application pre-installed on the mobile phone may be turned off when the Unison application is not in use. When the Unison application needs to be used, the user may need to manually use the F11 shortcut key to start Unison and manually open the Unison application on the mobile phone to implement the interconnection between PC and mobile phone. Therefore, the user's operations may be more complex. Moreover, when promoting the transmission function of the application, the user impression of the application may be not desirable, the use of the application may be not smart enough, and the willingness to use the application may be weakened. In addition, for large-sized products such as tablets, trigger actions may be not easily performed.

As disclosed above, the present disclosure provides the following solution.

Firstly, the mobile phone may be installed with a control application that may control the broadcast of the ultrasonic signal. The control application may only work with the IMU communication interface, and other modules may be hibernated to reduce power consumption.

Moreover, the mobile phone may use and detect the IMU data, for example, find preset action. Exemplarily, flipping the mobile phone (front-back-front) may be configured to control the application to work, and the ultrasonic signal may be emitted through the speaker. The PC may verify received ultrasonic signal.

Meanwhile, through the detection angle and detection distance of the ultrasonic signal, when the mobile phone is placed in a certain region of the computer (e.g., within 0.5 m of the PC), the mobile phone may start to connect the PC.

In addition, after the PC receives the ultrasonic signal, the PC may decode the ultrasonic signal and automatically wakes up the Unison application on the PC.

It may be seen that such implementation solution may have low power consumption and may not require the user to manually operate the PC and mobile phone. Simple actions may be used to wake up and pair the third-party applications such as the Unison application on the PC and mobile phone, which may be convenient for operation and promotion. Furthermore, after the mobile phone is connected to the PC, the authentication connection operation may be repeated to connect to third-party devices. For example, through the mobile phone for transit authentication, networking of three devices of computer, mobile phone and tablet may be implemented.

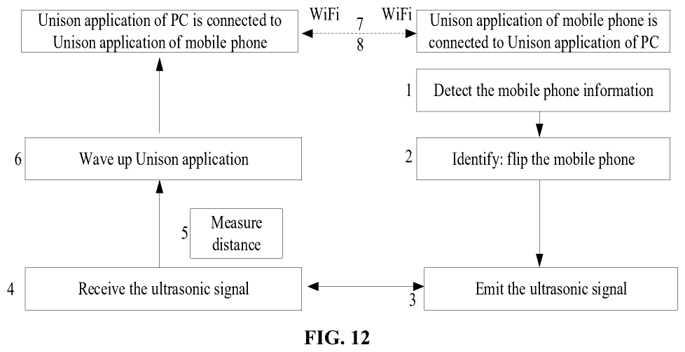

FIG. 11 illustrates an exemplary schematic of implementing application data transmission scenario between the mobile phone and the PC according to various embodiments of the present disclosure; and FIG. 12 illustrates a flowchart of application connection between a mobile phone and a PC according to various embodiments of the present disclosure. Referring to FIGS. 11-12, the application connection process between the mobile phone and the PC in the present disclosure is described in the following.
1) The mobile phone may ultrasonically control application Magic Move APP to run in the backend and detect the mobile phone information, that is, the device status mentioned above.
2) Magic Move APP of the mobile phone may identify the preset first condition, such as a certain signal corresponding to flipping the mobile phone.
3) Magic Move APP of the mobile phone may emit the ultrasonic signal of a frequency through the speaker, which may contain the identification code.
4) Magic Move APP of the PC may receive the ultrasonic signal which may be processed and decoded through an audio signal processor.
5) In response to that decoding verification is passed, the distance between the PC and the mobile phone may be measured through ultrasound. In response to that the device distance between the PC and the mobile phone is less than or equal to the preset distance threshold (e.g., 50 cm), the PC and the mobile phone may start to establish the device connection to prevent false triggering.
6) After verifying that the device distance between the PC and the mobile phone is less than or equal to the preset distance threshold, the mobile phone may wake up the Unison application, and the PC may also wake up the Unison application.
7) The Unison application of the PC and the Unison application of the mobile phone may be connected to each other. The WiFi modules inside the mobile phone and the PC may be turned on for device connection. Based on the device connection, the application connection may be established between the Unison application of the PC and the Unison application of the mobile phone.
8) Data transmission may begin between the Unison application of the PC and the Unison application of the mobile phone.

Various embodiments of the present disclosure provide an electronic device. The electronic device includes a memory, configured to store a computer program; and one or more processors, configured to, when the computer program is executed, perform a control method. The control method includes determining a device status of a first device; in response to that the device status of the first device satisfies a first condition, controlling the first device to broadcast a scan signal, such that a second device receiving the scan signal starts a second application when a second condition is satisfied; and establishing a data connection between a first application of the first device and the second application of the second device.

Various embodiments of the present disclosure provide a non-transitory computer-readable storage medium, containing a computer program for when executed by one or more processors, performing a control method. The control method includes determining a device status of a first device; in response to that the device status of the first device satisfies a first condition, controlling the first device to broadcast a scan signal, such that a second device receiving the scan signal starts a second application when a second condition is satisfied; and establishing a data connection between a first application of the first device and the second application of the second device.

Compared with the existing technology, the technical solutions provided by the present disclosure may implement at least the following beneficial effects.

It may be seen from above-mentioned technical solutions that in the control method and the electronic device provided in various embodiments of the present disclosure, the first device may be controlled to broadcast the scan signal based on that the device status of the first device satisfies the first condition, such that when the scan signal is received on the second device, the second application may be started in response to that the second condition is satisfied. Based on the above, the data connection between the first application of the first device and the second application of the second device may be established. It may be seen that in various embodiments of the present disclosure, the data connection between the applications on two devices may be controlled to be established based on the device status, and the application interconnection may be implemented without the user performing operations such as application startup on two devices, thereby reducing the user's operation complexity and improving the user experience.

In present disclosure, each embodiment may be described in a progressive manner. Each embodiment may focus on the differences from other embodiments. Same and similar parts between embodiments may be referred to each other. The apparatuses (devices) disclosed in various embodiments may correspond to methods disclosed in various embodiments, such that corresponding description may be relatively simple, and relevant parts may refer to the description of methods disclosed.

Those skilled in the art may further understood that the units and exemplary algorithm steps of each example described in conjunction with embodiments in the present disclosure may be implemented by electronic hardware, computer software, or a combination thereof. To clearly illustrate the interchangeability of hardware and software, the composition and exemplary steps of each example may have been described in above-mentioned description according to the functions. Whether above-mentioned functions are performed in hardware or software may depend on certain application and design constraints of technical solutions of the present disclosure. Those skilled in the art may use different methods to implement described functions for each application, but the implementation manners should not be considered to be beyond the protection scope of the present disclosure.

Exemplary steps of the methods or algorithms described in conjunction with embodiments of the present disclosure may be directly implemented by hardware, software modules executed by a processor, or a combination thereof. The software modules may be configured in a random-access memory (RAM), a memory, a read-only memory (ROM), an electrically programmable ROM, an electrically erasable programmable ROM, a register, a hard disk, a removable disk, a CD-ROM, or any other form of storage medium known in the technical field.

Above-mentioned description of disclosed embodiments may make those skilled in the art to implement or use the present disclosure. Various modifications to these embodiments may be apparent to those skilled in the art, and general principles defined herein may be implemented in other embodiments without departing from the spirit or protection scope of the present disclosure. Therefore, the present disclosure may not be limited to embodiments in the present disclosure but may conform to the widest scope consistent with the principles and novel features disclosed in the present disclosure.

What is claimed is:

1. A control method, comprising:
determining a device status of a first device;
in response to that the device status of the first device satisfies a first condition, controlling the first device to broadcast a scan signal, such that a second device receiving the scan signal starts a second application when a second condition is satisfied; and
establishing a data connection between a first application of the first device and the second application of the second device.

2. The method according to claim 1, wherein the device status of the first device satisfying the first condition includes at least one of following:
a device attitude change of the first device matches a preset target attitude;
object image-forming information collected by the first device indicates existence of the second device;
an environmental change status of the first device matches a preset target environmental status; and
a device application scenario of the first device matches a preset target application scenario.

3. The method according to claim 1, before establishing the data connection between the first application of the first device and the second application of the second device, further including:
after controlling the first device to broadcast the scan signal, starting the first application in the first device; or
when a relative position status between the second device and the first device satisfies the second condition, starting the first application in the first device, wherein:
the relative position status is obtained according to a feedback signal sent by the second device after receiving the scan signal; or the relative position status is received from the second device.

4. The method according to claim 1, before establishing the data connection between the first application of the first device and the second application of the second device, further including:
when feedback signals respectively from a plurality of receiving devices are received, selecting at least one second device satisfying a third condition from the plurality of receiving devices according to a device position of each receiving device; or
when feedback signals respectively from a plurality of receiving devices are received, determining at least one second device from the plurality of receiving devices in response to device selection operations for the plurality of receiving devices; or
when feedback signals respectively from a plurality of receiving devices are received, determining at least one second device from the plurality of receiving devices according to historical connection information of the first device.

5. The method according to claim 1, after establishing the data connection between the first application of the first device and the second application of the second device, further including:
monitoring whether the first device or the second device satisfies a fourth condition; and
when the first device or the second device satisfies the fourth condition, performing at least one of following processes:
suspending data transmission between the first application and the second application through the data connection;
adjusting a data transmission parameter of the data connection; and
hibernating the first device and/or the second device.

6. The method according to claim 5, wherein the fourth condition includes:
a relative position of the first device and the second device exceeds a preset position range; or
the device application scenario of the first device or the second device does not match the preset target application scenario; or
the first device and the second device do not receive any operation for a continuing target duration.

7. The method according to claim 1, wherein:
the scan signal at least includes an identification code of the first device, wherein:
the identification code is used by the second device to verify the first device; and
when the first device passes verification, a device connection is established between the first device and the second device and configured to implement the data connection.

8. The method according to claim 1, further including:
receiving the scan signal broadcasted by the first device, wherein the scan signal is broadcasted by the first device when the device status of the first device satisfies the first condition;
in response to the scan signal, starting the second application when the second device satisfies the second condition; and
establishing the data connection between the second application of the second device and the first application of the first device.

9. The method according to claim 8, wherein in response to the scan signal, starting the second application when the second device satisfies the second condition includes:
according to the scan signal, obtaining a communication position of the first device relative to the second device; and
when the communication position satisfies the second condition, starting the second application.

10. The method according to claim 8, wherein when scan signals broadcasted by a plurality of first devices are received, establishing the data connection between the second application of the second device and the first application of the first device includes:
according to the scan signals, obtaining a device position of each first device;
according to the device position of each first device, determining at least one target device from the plurality of first devices; and
establishing the data connection between the second application of the second device and the first application of a target device.

11. An electronic device, comprising:
a memory, configured to store a computer program; and
one or more processors, configured to, when the computer program is executed, perform:
determining a device status of a first device;
in response to that the device status of the first device satisfies a first condition, controlling the first device to broadcast a scan signal, such that a second device receiving the scan signal starts a second application when a second condition is satisfied; and
establishing a data connection between a first application of the first device and the second application of the second device.

12. The electronic device according to claim 11, wherein the one or more processors are configured to perform at least one of following:
a device attitude change of the first device matches a preset target attitude;
object image-forming information collected by the first device indicates existence of the second device;
an environmental change status of the first device matches a preset target environmental status; and
a device application scenario of the first device matches a preset target application scenario.

13. The electronic device according to claim 11, wherein the one or more processors are further configured to:
after controlling the first device to broadcast the scan signal, start the first application in the first device; or
when a relative position status between the second device and the first device satisfies the second condition, start the first application in the first device, wherein:
the relative position status is obtained according to a feedback signal sent by the second device after receiving the scan signal; or the relative position status is received from the second device.

14. The electronic device according to claim 11, wherein the one or more processors are further configured to:
when feedback signals respectively from a plurality of receiving devices are received, select at least one second device satisfying a third condition from the plurality of receiving devices according to a device position of each receiving device; or
when feedback signals respectively from a plurality of receiving devices are received, determine at least one second device from the plurality of receiving devices in response to device selection operations for the plurality of receiving devices; or
when feedback signals respectively from a plurality of receiving devices are received, determine at least one second device from the plurality of receiving devices according to historical connection information of the first device.

15. The electronic device according to claim 11, wherein the one or more processors are further configured to:
monitor whether the first device or the second device satisfies a fourth condition; and
when the first device or the second device satisfies the fourth condition, perform at least one of following processes:
suspending data transmission between the first application and the second application through the data connection;
adjusting a data transmission parameter of the data connection; and
hibernating the first device and/or the second device.

16. The electronic device according to claim 15, wherein the fourth condition includes:
a relative position of the first device and the second device exceeds a preset position range; or
the device application scenario of the first device or the second device does not match the preset target application scenario; or
the first device and the second device do not receive any operation for a continuing target duration.

17. The electronic device according to claim 11, wherein:
the scan signal at least includes an identification code of the first device, wherein:
the identification code is used by the second device to verify the first device; and
when the first device passes verification, a device connection is established between the first device and the second device and configured to implement the data connection.

18. The electronic device according to claim 11, wherein the one or more processors are further configured to:
receive the scan signal broadcasted by the first device, wherein the scan signal is broadcasted by the first device when the device status of the first device satisfies the first condition;
in response to the scan signal, start the second application when the second device satisfies the second condition; and
establish the data connection between the second application of the second device and the first application of the first device.

19. The electronic device according to claim 18, wherein the one or more processors are further configured to:
according to the scan signal, obtain a communication position of the first device relative to the second device; and
when the communication position satisfies the second condition, start the second application.

20. A non-transitory computer-readable storage medium containing a computer program that when being executed, causes one or more processors to perform:
determining a device status of a first device;
in response to that the device status of the first device satisfies a first condition, controlling the first device to broadcast a scan signal, such that a second device receiving the scan signal starts a second application when a second condition is satisfied; and
establishing a data connection between a first application of the first device and the second application of the second device.
